(19) United States
(12) Patent Application Publication
(10) Pub. No.: US 2007/0090929 A1
(43) Pub. Date: Apr. 26, 2007

(54) Display apparatus and control method thereof and network system comprising the same

(75) Inventor: Pan-jin Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/585,257

(22) Filed: Oct. 24, 2006

(30) Foreign Application Priority Data
Oct. 24, 2005 (KR) 10-2005-0100455

(51) Int. Cl. G09F 25/00

(52) U.S. Cl. 340/286.01

(57) ABSTRACT

A network system for generating predetermined alarm data pertaining to an electronic appliance and then transmitting the predetermined alarm data via an electronic appliance network module to a display apparatus is provided. A display network module of the display apparatus is connected to the electronic appliance network module via a network and receives the alarm data. A display control unit stores the alarm data in a storage if the alarm data are received via the display network module and controls the display of a predetermined alarm message which corresponds to the alarm data to notify the reception of the alarm data on a portion of the display. The alarm data can be displayed on a screen while the user views a displayed image without the displayed image being shielded by the alarm data which could abruptly appear on the currently displayed screen.

### CROSS-REFERENCE TO RELATED APPLICATIONS

This application claims priority under 35 U.S.C.§ 119 from Korean Patent Application No. 2005-0100455, filed on Oct. 24, 2005, the entire disclosure of which is hereby incorporated by reference.

### BACKGROUND OF THE INVENTION

1. Field of the Invention

Methods and apparatuses consistent with the present invention relate to a display apparatus and a network system comprising the display A apparatus, the display apparatus being capable of displaying an alarm data while an image is being displayed on a screen.

2. Description of the Related Art

In general, display apparatuses such as a Liquid Crystal Display (LCD), a Plasma Panel Display (PDP), and a Cathode Ray Tube (CRT), etc, are utilized, for example, as a TV monitor or computer monitor to display an image. It is now common for households to have one or more of these display apparatuses.

Meanwhile, as home information technologies have advanced, it becomes possible to construct a home network to interconnect home electronic appliances and conduct data communications between the home electronic appliances via the home network. Thus, the home appliances connected to the home network can be controlled via a predetermined home electronic appliance (for example, a Digital Television) which can play the role of a control server among the home electronic appliances. As the consumer's needs for such a home network have increased, data communications between the home appliances through the home network are diversified such that problems not anticipated in the past now frequently occur.

For example, in the related art, certain alarm data can be provided to the Digital TV from the home appliance connected to the home network, while an image is being displayed on the screen, e.g. a movie or a broadcasting program is being viewed by the user through the digital apparatus such as the Digital TV. In this case, the image being displayed on the Digital TV is shielded at least partially by the indication of the alarm data on the screen of the Digital TV. Therefore, the user may not be able to easily discern the alarm data, or cannot smoothly view the displayed image, since the displayed image may be partially shielded by the alarm data which could abruptly appear on the currently displaying screen.

### SUMMARY OF THE INVENTION

It is, therefore, an aspect of the present invention to provide a user with an enhanced display apparatus and a network system comprising the display apparatus, wherein alarm data can be displayed on a screen while the user views a displayed image without the displayed image being shielded by the alarm data which could abruptly appear on the currently displaying screen.

The foregoing and/or other aspects of the present invention are also achieved by providing a network system comprising: at least one electronic appliance comprising an electronic appliance network module connected to a network for conducting data communications, and an electronic appliance control unit for generating predetermined alarm data and then transmitting the predetermined alarm data via the electronic appliance network module; and a display apparatus comprising a display, a display network module connected to the electronic appliance network module via the network for receiving the alarm data, and a display control unit for storing the alarm data if the alarm data are received via the display network module and displaying a predetermined alarm message corresponding to the alarm data to notify the reception of the alarm data on a portion of the display.

According to an embodiment of the present invention, the display control unit comprises a User Interface (UI) generating unit which generates an alarm message signal which indicates the alarm message, a storage which stores the alarm data, and a microcomputer which controls the UI generating unit such that, if the alarm data are received through the display network module, the alarm data are stored into the storage and the alarm message signal is generated so as to display the predetermined alarm message corresponding to the alarm data on a portion of the display in order to notify the reception of the alarm data.

According to an embodiment of the present invention, the microcomputer controls the UI generating unit so that the alarm message is not displayed if a predetermined period has elapsed after the alarm message was displayed on a portion of the display.

According to an embodiment of the present invention, the network system further comprises a signal processing unit which receives at least one of an image signal input externally and the alarm message signal and then processes the received signal to be displayed on the display, and a user input unit for a user's manipulation, wherein the microcomputer determines whether displaying the alarm data is selected via the user input unit while the alarm message is being displayed on the display, and if it is determined that displaying the alarm data is selected, the microcomputer controls the signal processing unit so that the alarm data stored in the storage are processed corresponding to the alarm message and then displayed on the display.

According to an embodiment of the present invention, the microcomputer determines whether the alarm data is stored in the storage if indicating the alarm data is selected via the user input unit while the alarm message is not displayed on the display, and if it is determined that the alarm data is stored in the storage, the microcomputer controls the UI generating unit and the signal processing unit so that an alarm message list in which the alarm messages corresponding to the stored alarm data are arranged sequentially in a row according to a stored order is displayed on the display.

According to an embodiment of the present invention, the microcomputer determines which alarm message in the alarm message list is selected via the user input unit while the alarm message list is being displayed on the display, and if one of the alarm messages is selected, the microcomputer controls the signal processing unit so that the alarm data stored in the storage are processed corresponding to the selected alarm message and then displayed on the display.

According to an embodiment of the present invention, the electronic appliance control unit previously stores abnormal operation information related to pre-set abnormal operations which trigger the generation of the alarm data, checks whether the operation of the electronic appliance is normally progressed, compares a result of the check with the abnormal operation information, and if operation state of the electronic appliance is determined to be a pre-set abnormal operation state, the electronic appliance control unit creates the alarm data to be transferred via the electronic appliance network module.

According to an embodiment of the present invention, the alarm data comprise at least one of name information of the electronic appliance, transfer date information, cause information of the abnormal operations, and simplified solution information recommended for resolving the cause of the abnormal operations.

According to an embodiment of the present invention, the alarm messages comprise at least one of alarm information for notifying the reception of the alarm data, electronic appliance indicating information corresponding to the electronic appliance which transfers the received alarm data, and simplified cause information with respect to the cause information included in the alarm data, as one of the forms of text type or symbol type.

According to an embodiment of the present invention, the microcomputer previously stores the abnormal operation information related to the pre-set abnormal operations which trigger the generation of the alarm data, checks whether the operation of the display apparatus is normally progressed, compares the result of the check with the abnormal operation information, and if the operation state of the display apparatus is determined to be a pre-set abnormal operation state, the microcomputer creates the alarm data, stores the data into the storage, controls the UI generating unit and the signal processing unit so that a predetermined alarm message corresponding to the alarm data is displayed on a portion of the display in order to notify the reception of the alarm data.

The foregoing and/or other aspects of the present invention are also achieved by providing a display apparatus comprising: a display; a display network module connected to a network for conducting data communications; and a display control unit for determining whether predetermined alarm data are received from external electronic appliances connected via the display network module, storing the predetermined alarm data if the alarm data are received and displaying a predetermined alarm message corresponding to the alarm data to notify the reception of the alarm data on a portion of the display.

According to an embodiment of the present invention, the display control unit comprises a UI generating unit for generating the alarm message signal to indicate the alarm message, a storage for storing the alarm data, and a microcomputer which controls the UI generating unit such that, if the alarm data are received through the display network module, the alarm data are stored in the storage and the alarm message signal is generated so as to display the predetermined alarm message corresponding to the alarm data on a portion of the display in order to notify the reception of the alarm data.

According to an embodiment of the present invention, the microcomputer controls the UI generating unit so that the alarm message is not displayed if a predetermined period has elapsed after the alarm message was displayed on a portion of the display.

According to an embodiment of the present invention, the display apparatus further comprises a signal processing unit for receiving at least one of an image signal input externally and the alarm message signal and then processing the received signal to be displayed on the display, and a user input-unit for a user's manipulation, wherein the microcomputer determines whether displaying the alarm data is selected via the user input unit while the alarm message is being displayed on the display, and if it is determined that displaying the alarm data is selected, the microcomputer controls the signal processing unit so that the alarm data stored in the storage are processed corresponding to the alarm message and then displayed on the display.

According to an embodiment of the present invention, the microcomputer determines whether the alarm data is stored in the storage if indicating the alarm data is selected via the user input unit while the alarm message is not displayed on the display, and if it is determined that the alarm data is stored in the storage, the microcomputer controls the UI generating unit and the signal processing unit so that an alarm message list in which the alarm messages corresponding to the stored alarm data are arranged sequentially in a row according to a stored order is displayed on the display.

According to an embodiment of the present invention, the microcomputer determines which alarm message in the alarm message list is selected via the user input unit while the alarm message list is being displayed on the display, and if one of the alarm messages is selected, the microcomputer controls the signal processing unit so that the alarm data stored in the storage are processed corresponding to the selected alarm message and then displayed on the display.

According to an embodiment of the present invention, the alarm data comprise at least one of name information of the electronic appliance, transfer date information, cause information of the abnormal operations, and simplified solution information recommended for resolving the cause of the abnormal operations.

According to an embodiment of the present invention, the alarm messages comprise at least one of alarm information for notifying the reception of the alarm data, electronic appliance indicating information corresponding to the electronic appliance which transfers the received alarm data, and simplified cause information with respect to the cause information included in the alarm data, as one of the forms of text type or symbol type.

According to an embodiment of the present invention, the microcomputer previously stores the abnormal operation information related to the pre-set abnormal operations which trigger the generation of the alarm data, checks whether the operation of the display apparatus is normally progressed, compares a result of the check with the abnormal operation information, and if the operation state of the display apparatus is determined to be a pre-set abnormal operation state, the microcomputer creates the alarm data, stores the data in the storage, controls the UI generating unit and the signal processing unit so that a predetermined alarm message corresponding to the alarm data is displayed on a portion of the display in order to notify the reception of the alarm data.

The foregoing and/or other aspects of the present invention are also achieved by providing a control method of a display apparatus comprising: a display network module connected to a network for conducting data communications; and a display control unit for determining whether predetermined alarm data are received from an external electronic appliance connected via the display network module, storing the predetermined alarm data if the alarm data are received and displaying a predetermined alarm message corresponding to the alarm data to notify the reception of the alarm data on a portion of the display.

### BRIEF DESCRIPTIONS OF THE DRAWINGS

The above and/or other aspects of the present invention will become apparent and more readily appreciated from the following description of the exemplary embodiments, taken in conjunction with the accompanying drawings of which:

FIG. 1 is a view showing an external construction of a network system according to an exemplary embodiment of the present invention;

FIG. 2 is a control block diagram of a network system according to one exemplary embodiment of the present invention;

FIG. 3 is a control flowchart of home electronic appliances in a network system according to one exemplary embodiment of the present invention;

FIG. 4 is a control flowchart of a display apparatus according to one exemplary embodiment of the present invention; and

FIGS. 5A, 5B and 5C illustrate an alarm message, a list of the alarm message, and an alarm data, respectively, in a display apparatus according to an exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings.

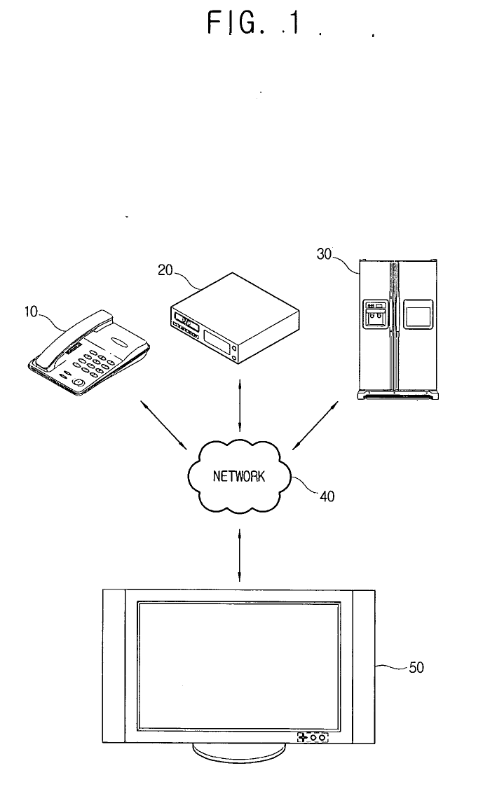

As shown in FIG. 1, a network system of the present invention comprises a display apparatus such as Digital TV 50 connected to a network 40, and at least one home electronic appliance 10, 20 and 30 connected to the Digital TV 50 via the network 40. In this example, the electronic appliances connected to the network 40 are a telephone 10, a DVD player 20 and a refrigerator 30.

Even though the electronic appliances are depicted to only comprise the telephone 10, the DVD player 20 and the refrigerator 30 as illustrated in FIG. 1, it is easily appreciated that a variety of home appliances can be further connected to the network 40. In the network system of the exemplary embodiment of the present invention described in FIG. 1 and all the other drawings hereinafter, the display apparatus such as the Digital TV 50 plays the role of a control server for controlling all the home appliances connected to the network 40, according to one exemplary embodiment of the present invention.

Here, the network 40 is an interface for interconnecting the home appliances 10, 20, 30 and the Digital TV 50 to enable a data communication between the home appliances 10, 20, 30 and the Digital TV 50. This network 40 may be constructed by any one of network constitutions such as a power line communication, an IEEE 1394, an Ethernet, a wireless LAN, a wired LAN, etc.

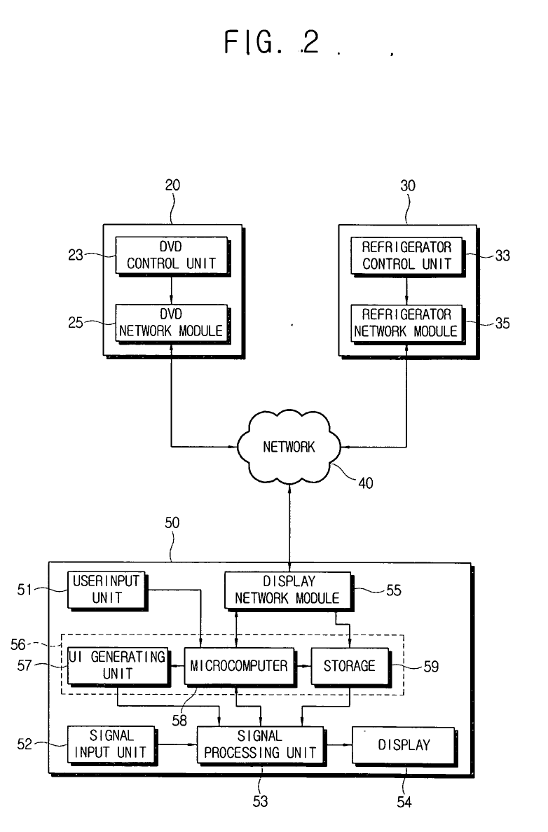

FIG. 2 shows a control block diagram of the network system according to one exemplary embodiment of the present invention. For simplicity, only the Digital TV 50, the DVD player 20 and the refrigerator 30 among the elements of FIG. 1 are depicted in FIG. 2.

The DVD player 20 includes a DVD network module 25 connected to the network 40 for conducting a data communication, and a DVD control unit 23 for creating predetermined alarm data and transferring the alarm data through the DVD network module 25.

The DVD network module 25 processes the alarm data created in the DVD control unit 23 so as to enable the alarm data to be transferred to the Digital TV 50 through the network 40. Then, the alarm data are transferred to the Digital TV 50 through the network 40.

Here, the DVD control unit 23 pre-stores abnormal operation information regarding abnormal operations previously set to create the alarm data. Statuses corresponding to pre-set abnormal states for which alarm data are to be created are exemplified as below: a status where a recording function cannot be conducted normally since a DVD for recording is not inserted into the DVD player 20 when the DVD player 20 is intended to perform the recording function; or another status where a reproduction function cannot be conducted normally since a DVD not compatible with the DVD player 20 is inserted into the DVD player 20 when the DVD player 20 is intended to perform the reproduction function. Also, the DVD control unit 23 continuously checks whether the operation of the DVD player 20 is conducted normally and then compares the result of the check with the abnormal operation information. If it is determined that the operation state of the DVD player 20 is of the predetermined abnormal operations, the DVD control unit 23 creates an alarm data corresponding to the currently checked abnormal operation state and transfers the alarm data through the DVD network module 25.

The refrigerator 30 comprises a refrigerator network module 35 connected to the network 40 for performing a data communication, and a refrigerator control unit 33 for creating a predetermined alarm data and transferring the alarm data through the refrigerator network module 35.

The refrigerator network module 35 processes the alarm data created in the refrigerator control unit 33 to be transferred, and then transfers the alarm data to the Digital TV 50 through the network 40.

Here, the refrigerator control unit 33 pre-stores abnormal operation information regarding the abnormal operations previously set to create the alarm data. For example, statuses corresponding to the pre-set abnormal states for which the alarm data is to be created are exemplified as below: a status where a freezer or a cold storage of the refrigerator 30 is not maintained at an operating temperature; or another status where a door of the freezer or the cold storage of the refrigerator 30 is opened for an extended period. Also, the refrigerator control unit 33 continuously checks whether or not the operation of the refrigerator 30 is conducted normally and compares the result of the check with the abnormal operation information. If it is determined that the operation state of the refrigerator 30 is of the predetermined abnormal operation, the refrigerator control unit 33 creates an alarm data corresponding to the currently checked abnormal operation state and transfers the alarm data through the refrigerator network module 35.

It is preferable but not necessary that the alarm data transferred from the DVD player 20 or the refrigerator 30 comprises a variety of information regarding the currently generated abnormal operations. The variety of information may comprise, for example, name information of the home appliances transferring the alarm data, transferring date information, detailed information of the cause of the abnormal operations, simplified solution information recommended for resolving the cause of the abnormal operations, etc. Here, the alarm data transferred from the DVD player 20 comprises, for example, at least one of the name information of the home appliance (e.g. a DVD player), the transferring date information (e.g. Oct. 20, 2005), the information of the cause of the abnormal operations (e.g. DVD not inserted into the DVD player for reproduction), and the simplified solution information recommended for resolving the cause of the abnormal operations.

On creating the alarm data, the DVD control unit 23 and the refrigerator control unit 33 can generate the alarm data in various formats of text or graphic such as an HTML format, BITMAP format, etc.

The Digital TV 50 may comprise a user input unit 51, a signal input unit 52, a signal processing unit 53, a display 54, a display network module 55 and a display control unit 56.

The user input unit 51 outputs a keystroke signal to a microcomputer 58 of the display control unit 56, which will be described later, according to the user's keystroke. The user input unit 51 may comprise an alarm-indicating key for requesting the indication of the alarm data, navigation upper/lower/left/right keys, and an EXIT key. The user input unit 51 may further comprise a keystroke signal generating unit for generating a keystroke signal according to the keystroke.

The user input unit 51 may be mounted on the front of the Digital TV 50 or may be prepared by a separately connected input means such as a mouse (not shown) or a keyboard (not shown), or else by a remote control. Here, if the user makes a keystroke, the keystroke signal generating unit generates the keystroke signal to apply the keystroke signal to the microcomputer 58. Thus, the microcomputer 58 can control the signal processing unit 53 and also a User Interface (UI) generating unit 57, all of which will be described later, according to the keystroke signal input from the keystroke signal generating unit of the user input unit 51.

The signal input unit 52 behaves as a function unit for conducting a reception function for receiving an image signal externally. The signal input unit 52 can be prepared by a connecting terminal to which an input cable is connected, or by an antenna for receiving a broadcasting signal.

The signal processing unit 53 transforms the image signal input via the signal input unit 52 into a signal having a format adapted for the display 54 and outputs the transformed signal to the display 54. The signal processing unit 53 may comprise a signal transforming unit for transforming the image signal input via the signal input unit 52, and a scaler for scaling the image signal output from the signal transforming unit into a displayable format for the display 54.

Also, the signal processing unit 53 receives one of an alarm message signal and an alarm message list signal output from the UI generating unit 57, which will be described later. The signal processing unit 53 processes an image signal and one of the alarm message signal and the alarm message list signal so that an image screen according to the image signal input through the signal input unit 52 and one of the alarm message and the alarm message list according to the alarm message signal and the alarm message list signal are displayed together on the display 54. At this time, it is preferable but not necessary that the display size and display position of the alarm message is pre-set in the signal processing unit 53 so that the alarm message can be displayed at a portion of the display 54. For example, the signal processing unit 53 can process the alarm message signal output from the UI generating unit 57, which will be described later, so that the alarm message can be displayed with the predetermined small size at the lower right of the display 54.

Also, the signal processing unit 53 reads out the certain alarm data pre-stored in the storage 59, pursuant to the control of the microcomputer 58 which will be described later, and then transforms the read-out alarm data into a data having a format adapted for the display 54. Then, the transformed data is output to the display 54. At this time, it is preferable but not necessary that the signal processing unit 53 perform a process appropriate to a data format of the read-out data (for example, various kinds of text or graphic format such as HTML or BITMAP) so that the processed signal is output to the display 54. Here, the signal processing unit 53 may process the image signal and the alarm data concurrently so that the image screen according to the image signal input via the signal input unit 52 and the alarm data screen according to the alarm data are indicated together on the display 54. In another case, the signal processing unit 53 may process the alarm data so that only the alarm data screen according to the alarm data is indicated on the display 54.

The display 54 receives the image signal processed by the signal processing unit 53 as an input and displays the image screen accordingly. The display 54 may comprise a display panel (not shown) on which the image is displayed, and a panel driver (not shown) which processes the image signal input from the signal processing unit 53 so that the image is to be displayed on the display panel.

The display network module 55 is connected to the DVD network module 25 and the refrigerator network module 35 via the network 40 to receive the alarm data provided from the DVD player 20 and the refrigerator 30. Of course, the display network module 55 may process certain data to be transferred to the DVD player 20 and the refrigerator 30 via the network 40.

The display control unit 56 may comprise the UI generating unit 57 for generating the alarm message signal to indicate the alarm message, a storage 59 for storing the alarm data, and the microcomputer 58 which controls the UI generating unit 57 such that, if the alarm data is received through the display network module 55, the microcomputer 58 enables the alarm data to be stored into the storage 59 and then enables the alarm message signal to be generated so as to display a certain alarm message corresponding to the alarm data in a portion of the display 54 in order to notify the reception of the alarm data.

The storage 59 stores the alarm data received via the display network module 55, according to the control of the microcomputer 58. At this time, it is preferable but not necessary for the storage 59 to store the received alarm data on reception order. Also, the storage 59 preferably but not necessarily does not continue storing the alarm data read out by the signal processing unit 53.

The UI generating unit 57 creates the alarm message signal in order to display the predetermined alarm message corresponding to the alarm data received via the display network module 55 under the control of the microcomputer 58, and then outputs the alarm message signal to the signal processing unit 53. Also, the UI generating unit 57 creates the alarm message list signal in order to display an alarm message list on the display 54, in which the alarm messages corresponding to the alarm data stored in the storage 56 are arranged sequentially in a row following the stored order, and then the alarm message list signal is output to the signal processing unit 53.

It is preferable but not necessary that the alarm messages, which may be at least one of the alarm information (e.g. error presence/non-presence) notifying whether the alarm data are received or not, the home appliance indicating information (e.g. a DVD player) corresponding to the home appliance which transfers the received alarm data, and the simplified cause information (e.g. non-inserting of DVD) with respect to the cause information included in the alarm data, are, indicated as at least one of the forms of text type or symbol type.

The UI generating unit 57, which creates the alarm message signal and the alarm message list signal in order to display the alarm message and the alarm message list, can prepared by an On Screen Display (OSD) processor, or by a BITMAP processor, or by any other devices which can display the alarm message and the alarm message list.

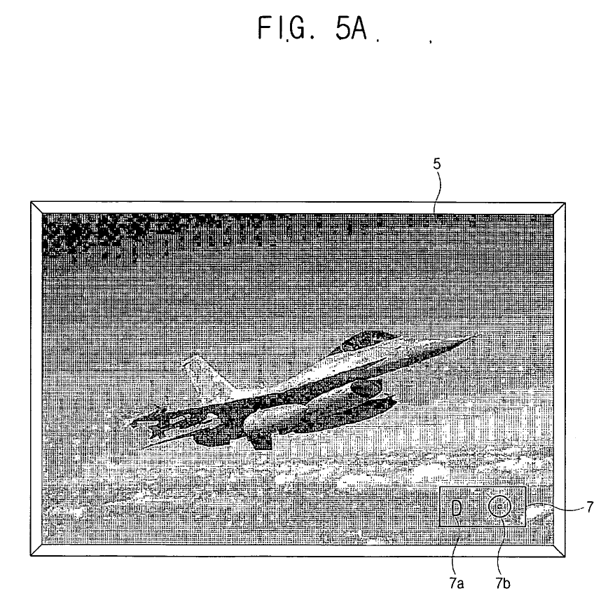

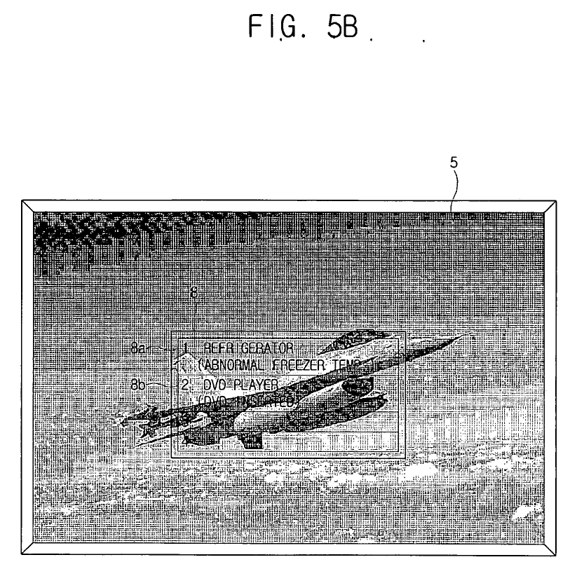

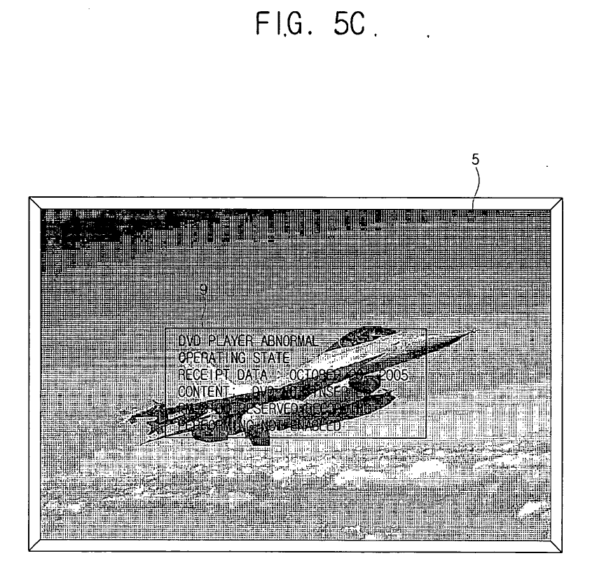

The microcomputer 58 determines whether or not the alarm data are received from the home appliances 20 and 30 connected to the network 40 via the display network module 55. The microcomputer 58 allows the alarm data to be stored into the storage 59 if the alarm data is received, controls the UI generating unit 57 so that a certain alarm message signal corresponding to the alarm data is created in order to notify the reception of the alarm data, and controls the signal processing unit 53 to display the alarm message corresponding to the alarm message signal at a portion (e.g. lower right) of the display 54. Accordingly, as shown in FIG. 5A, an alarm message 7 of a certain small size is displayed, for example, at the lower right of the image screen 5 being displayed on the display 54. Here, the alarm message 7 is exemplified to have appliance indicating information 7a corresponding to the home appliance (e.g. DVD player 20) that transferred the alarm data, and a simplified cause information 7b with respect to the cause information (DVD is not inserted) included in the alarm data, both of which are displayed in simplified symbol form.

Here, the microcomputer 58 determines whether displaying the alarm data is selected via the user input unit 51 while the alarm message is being displayed on the display 54. If it is determined that displaying the alarm data during the display of the alarm message is selected, the microcomputer 58 controls the signal processing unit 53 so that the alarm data stored in the storage 59 is processed in correspondence with the displayed alarm message and then displayed on the display 54. Here, if displaying the alarm data is selected as shown in FIG. 5A while the alarm message 7 is being displayed on the display 54, then the alarm data screen 9 corresponding to the alarm message 7 is displayed as shown in FIG. 5C. Here, the alarm data screen 9 is exemplified to display home appliance (e.g. DVD player 20) name information corresponding to the home appliance which transferred the alarm data, transfer date information, detailed cause information of the abnormal operations, and simplified solution information recommended for resolving the cause of the abnormal operations, etc, as a text form.

If the alarm data is transferred to the Digital TV 50 from the home appliances 20 and 30 connected to the network 40, the network system according to an exemplary embodiment of the present invention, displays in small size only the simple alarm message regarding the alarm data received at the Digital TV 50 on a portion of the display 54 to inform the user. Additionally, the content of the alarm data may be displayed only if display of the alarm data is selected. Accordingly, the network system according to an exemplary embodiment of the present invention can resolve inconveniences caused by an abrupt appearance of the alarm data on the image screen while the image is being displayed, and thus the convenience of the user is greatly enhanced.

The microcomputer 58 determines whether or not a predetermined period has elapsed without selecting the display of the alarm data via the user input unit 51 while the alarm message is being displayed on a portion of the display 54. As a result of the determination, if the predetermined period has elapsed, the microcomputer 58 controls the UI generating unit 57 to disable the display of the alarm message. At this time, when the user was notified of the arrival of the alarm data by the indication of the alarm message, the alarm message itself may not be displayed if the user does not want to display the alarm data.

The microcomputer 58 also determines whether or not indicating the alarm data is selected via the user input unit 51 while the alarm message is not displayed on the display 54. If it is determined that indicating the alarm data is selected, the microcomputer 58 determines whether or not the alarm data is stored at the storage 59. If the alarm data is stored in the storage 59, the microcomputer 58 controls the UI generating unit 57 to create the alarm message list signal in order to display the alarm messages list in which the alarm messages corresponding to the stored alarm data are arranged sequentially in a row according to the stored order. And then, the microcomputer 58 controls the signal processing unit 53 to display the alarm message list according to the alarm message list signal on a portion of the display 54. Thus, as shown in FIG. 5b, the alarm message list 8 is displayed, in which the alarm messages are arranged sequentially in a row according to the order of the alarm data received and stored in the storage 59. Here, the alarm message list may be, for example, comprised of an alarm message 8a of the refrigerator 30 stored earlier and another alarm message 8b of the DVD player 20 stored later, each of which may be constituted by appliance indicating information corresponding to the home appliance (a refrigerator, or DVD player) and simplified cause information with respect to the cause information (freezer temperature abnormality, or the DVD is not inserted) included in the alarm data. In this case, the alarm message list may be expressed by a simplified text form, for example.

Accordingly, the alarm messages of the alarm data, which are not yet displayed on the display 54 even though the alarm data were transferred from the appliances 20 and 30 to the Digital TV 50, can be effectively displayed according to the received order, if the user wishes to confirm the alarm data. Thus, the user can effectively confirm the alarm data which have not yet been confirmed even though the alarm data was transferred from the appliances 20 and 30 to the Digital TV.

On this occasion, the microcomputer 58 determines which alarm message in the alarm message list is selected via the user input unit 51 while the alarm message list is being displayed on the display 54. Accordingly, selecting one of the alarm messages in the alarm message list can be conducted through the key manipulations of upper/lower/left/right navigation keys by the user input unit 51. If one of the alarm messages is selected in the alarm messages list, the microcomputer 58 controls the signal processing unit 53 to read out/process the alarm data stored in the storage 59 in correspondence with the selected alarm message and then display the read out/processed alarm data on the display 54.

The network system according to an exemplary embodiment of the present invention displays the alarm message list of the alarm data which were transferred from the appliances 20 and 30 but not displayed on the Digital TV 50, according to a user's request for displaying the alarm data, and then displays the alarm data selected in the alarm message list. Therefore, the network system according to an exemplary embodiment of the present invention solves the related art inconvenience that an image being displayed is shielded by an abrupt display of the alarm data. Further, the network system according to an exemplary embodiment of the present invention effectively provides the alarm data that could be stored without being displayed. Thus, the user's convenience can be greatly enhanced in displaying the alarm data.

In the above-described exemplary embodiment, the display apparatus, which receives the alarm data from the appliances 20 and 30 connected to the network 40 and displays the alarm data, is described as comprising only the Digital TV. But the present invention is not limited to this exemplary embodiment. Any apparatus which has a construction that can receive and display alarm data from the appliances 20 and 30 connected to the network 40, including the display network module 55 and the display 54, can be utilized as the display apparatus.

The microcomputer 58 previously stores the abnormal operation information with respect to the pre-set abnormal operations which trigger the generation of the alarm data, continuously checks whether the operation of the Digital TV 50 is normally progressed, and compares a result of the check with the abnormal operation information. If the operation state of the Digital TV 50 is determined to be one of the pre-set abnormal operation states, the microcomputer 58 creates the alarm data corresponding to the currently checked abnormal operation, stores the alarm data into the storage 59, controls the UI generating unit 57 to generate a predetermined alarm message signal in correspondence with the alarm data, and controls the signal processing unit 53 to display the alarm message on a portion (e.g. lower right) of the display 54 according to the alarm data. Accordingly, the Digital TV 50 may display the alarm message, which corresponds to the alarm data created by the Digital TV 50 itself, with a predetermined size at the lower right of the image screen displayed on the display 54, in the same way as when the alarm data are received from the appliances 20 and 30.

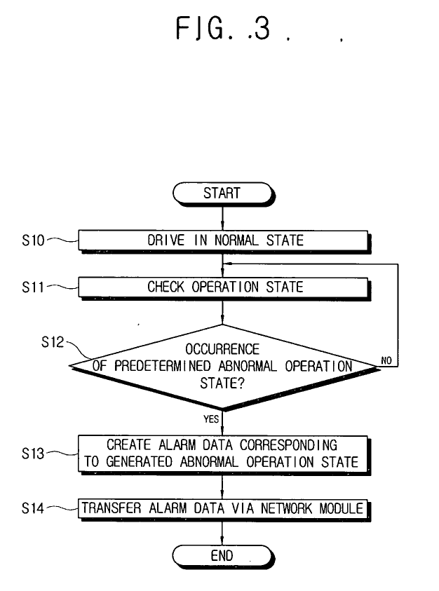

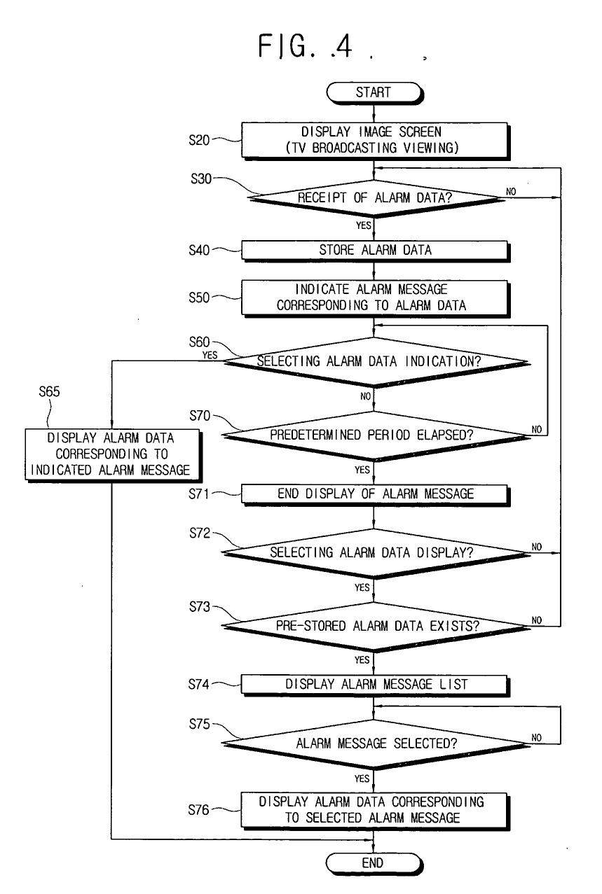

Hereinafter, a flow of control method of the network system according to an exemplary embodiment of the present invention will be described in detail with reference to FIGS. 3 and 4. FIG. 3 shows a control flowchart of the appliances 20 and 30 in the network system according to an exemplary embodiment of the embodiment of the present invention. FIG. 4 shows a control flow chart of the digital TV according to one exemplary embodiment of the present invention.

First, the control flow of the appliances 20 and 30 will be described with reference to FIG. 3. For simplicity, the control flow of the electronic appliances through the DVD layer 20 is described.

It is first assumed that the DVD player 20 is operating in a normal state at operation S10. Of course, the DVD control unit 23 previously stores abnormal operation information with respect to abnormal operations that are pre-set to trigger generation of alarm data. Here, the DVD control unit 23 continuously checks whether the operation of the DVD player 20 is conducted normally at operation S11, compares a result of the check with the abnormal operation information and then determines whether or not pre-set abnormal operation state occurred in the DVD player 20 at operation S12. If it is determined that the pre-set abnormal operation state was generated, the DVD control unit 23 creates alarm data corresponding to the currently generated abnormal operation at operation S13, and then sends the alarm data to the Digital TV 50 via the DVD network module 25 at operation S14. Of course, the above operations S10 to S14 may be performed similarly at the refrigerator 30. Any appliance connected to the network 40, which are capable of sending alarm data to the Digital TV 50, may perform the above operations in common.

Meanwhile, as depicted in FIG. 4, the Digital TV 50 of the display apparatus according to an exemplary embodiment of the present invention determines whether or not the alarm data are received from the appliances 20 and 30 connected to the network 40 via the display network module 55 at operation S30, while the image screen (e.g. TV broadcasting) according to the image signal input via the signal input unit 52 is being displayed at operation S20. If it is determined that the alarm data are received, the microcomputer 58 stores the alarm data into the storage 59 at operation S40, and then controls the UI generating unit 57 and the signal processing unit 53 to display a predetermined alarm message corresponding to the alarm data on a portion (e.g. lower right portion) of the display 54 in order to inform the reception of the alarm data at operation S50.

The microcomputer 58 determines whether or not displaying the alarm data is selected by the user via the user input unit 51 while the alarm message is being displayed on the display 54 at operation S60. If it is determined that displaying the alarm data is selected during the display of the alarm message, the microcomputer 58 controls the signal processing unit 53 to process the alarm data stored in the storage 59 and corresponding to the alarm message and then display the processed alarm data on the display 54 at operation S65.

On the other hand, if the alarm message is displayed on a portion of the display 54 and displaying the alarm data are not selected at operation S60, the microcomputer 58 determines whether or not a predetermined period has elapsed at operation S70. If it is determined that the predetermined period has elapsed, the microcomputer 58 controls the UI generating unit 57 to terminate the display of the alarm message at operation S71.

Also, the microcomputer 58 determines whether or not the displaying the alarm data are selected via the user input unit 51 while the alarm message is not being displayed on the display 54 at operation S72. If it is determined that displaying the alarm data is selected, the microcomputer 58 determines whether or not pre-stored alarm data exist in the storage 59 at operation S73. If the alarm data stored in the storage 59 exist, the microcomputer controls the UI generating unit and the signal processing unit 53 to display the alarm message list, in which the alarm messages corresponding to the pre-stored alarm data are arranged sequentially in a row according to the stored order, on the display 54 at operation S74. Accordingly, if the user wants to confirm alarm data which were transferred from the appliances 20 and 30 but are not displayed on the display 54, simple information (an alarm message) corresponding to the received alarm data can be effectively displayed according to the received order.

On this occasion, the microcomputer 58 determines whether or not one of the alarm messages in the alarm message list is selected via the user input unit 51 while the alarm message list is being displayed on the display 54 at operation S75. If one of the alarm messages in the alarm message list is selected, the microcomputer 58 controls the signal processing unit 53 to read out/process the alarm data stored in the storage 59 and corresponding to the selected alarm message and then display the read out/processed alarm data on the display 54 at operation S76.

Thus, the network system according to an exemplary embodiment of the present invention solves the related art inconvenience that a viewing is shielded by the abrupt display of alarm data while an image is being displayed on the screen, as well as effectively provides the alarm data which could be stored without being displayed. Thus, the user's convenience can be greatly enhanced.

As is apparent from the above description, the network system according to the exemplary embodiments of the present invention displays the alarm message pertaining to the alarm data if the alarm data are received from the appliances, and then displays the alarm data if a user's request for displaying the alarm data is provided. Therefore, the network system according to the exemplary embodiments of the present invention solves the related art inconvenience that a viewing is shielded by the abrupt display of the alarm data while the image is being displayed, as well as effectively provides the alarm data, which could be stored without being displayed, according to the user's request.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A network system comprising:
at least one electronic appliance comprising an electronic appliance network module connected to a network which conducts data communications, and an electronic appliance control unit which generates predetermined alarm data and then transmits the predetermined alarm data via the electronic appliance network module; and
a display apparatus comprising a display, a display network module connected to the electronic appliance network module via the network which receives the alarm data, and a display control unit which stores the alarm data if the alarm data are received via the display network module and displays a predetermined alarm message corresponding to the alarm data to notify the reception of the alarm data on a portion of the display.

2. The network system according to claim 1, wherein the display control unit comprises a User Interface (UI) generating unit which generates an alarm message signal to indicate the alarm message, a storage which stores the alarm data, and a microcomputer which controls the UI generating unit such that, if the alarm data are received through the display network module, the alarm data are stored into the storage and the alarm message signal is generated so as to display the predetermined alarm message corresponding to the alarm data on a portion of the display in order to notify the reception of the alarm data.

3. The network system according to claim 2, wherein the microcomputer controls the UI generating unit so that a display of the alarm message is terminated if a predetermined period has elapsed after the alarm message was displayed on a portion of the display.

4. The network system according to claim 3, further comprising a signal processing unit which receives at least one of an image signal input from an external source and the alarm message signal and then processes at least one of the image signal and the alarm message signal to be displayed on the display, and a user input unit for a user's manipulation,
wherein the microcomputer determines whether displaying the alarm data is selected via the user input unit while the alarm message is being displayed on the display, and if it is determined that displaying the alarm data is selected, the microcomputer controls the signal processing unit so that the alarm data stored in the storage are processed corresponding to the alarm message and then displayed on the display.

5. The network system according to claim 4, wherein the microcomputer determines whether the alarm data is stored in the storage if indicating the alarm data is selected via the user input unit while the alarm message is not displayed on the display, and if it is determined that the alarm data is stored in the storage, the microcomputer controls the UI generating unit and the signal processing unit so that an alarm message list in which alarm messages corresponding to the stored alarm data are arranged sequentially in a row according to a stored order is displayed on the display.

6. The network system according to claim 5, wherein the microcomputer determines which alarm message in the alarm message list is selected via the user input unit while the alarm message list is being displayed on the display, and if one of the alarm messages is selected, the microcomputer controls the signal processing unit so that the alarm data stored in the storage are processed corresponding to the selected alarm message and then displayed on the display.

7. The network system according to claim 6, wherein the electronic appliance control unit previously stores abnormal operation information related to pre-set abnormal operations which trigger the generation of the alarm data, checks whether the operation of the electronic appliance is normally progressed, compares a result of the check with the abnormal operation information, and if operation state of the electronic appliance is determined to be a pre-set abnormal operation state, the electronic appliance control unit creates the alarm data to be transferred via the electronic appliance network module.

8. The network system according to claim 7, wherein the alarm data comprise at least one of name information of the electronic appliance, transfer date information, cause information of the abnormal operations, and simplified solution information recommended for resolving the cause of the abnormal operations.

9. The network system according to claim 8, wherein the alarm messages comprise at least one of alarm information for notifying the reception of the alarm data, electronic appliance indicating information corresponding to the electronic appliance which transfers the received alarm data, and simplified cause information with respect to the cause information included in the alarm data, as one of the forms of text type or symbol type.

10. The network system according to claim 9, wherein the microcomputer previously stores the abnormal operation information related to the pre-set abnormal operations which trigger the generation of the alarm data, checks whether the operation of the display apparatus is normally progressed, compares the result of the check with the abnormal operation information, and if the operation state of the display apparatus is determined to be a pre-set abnormal operation state, the microcomputer creates the alarm data, stores the data into the storage, controls the UI generating unit and the signal processing unit so that a predetermined alarm message corresponding to the alarm data is displayed on a portion of the display in order to notify the reception of the alarm data.

11. A display apparatus comprising:
a display network module connected to a network which conducts data communications; and
a display control unit which determines whether predetermined alarm data are received from an external electronic appliance connected via the display network module, stores the predetermined alarm data if the alarm data are received and controls a display of a predetermined alarm message which corresponds to the alarm data to notify the reception of the alarm data on a portion of a display.

12. The display apparatus according to claim 11, wherein the display control unit comprises a User Interface (UI) generating unit which generates the alarm message signal to indicate the alarm message, a storage which stores the alarm data, and a microcomputer which controls the UI generating unit such that, if the alarm data are received through the display network module, the alarm data are stored in the storage and the alarm message signal is generated so as to display the predetermined alarm message corresponding to the alarm data on a portion of the display in order to notify the reception of the alarm data.

13. The display apparatus according to claim 12, wherein the microcomputer controls the UI generating unit so that the display of the alarm message is terminated if a predetermined period has elapsed after the alarm message was displayed on a portion of the display.

14. The display apparatus according to claim 13, further comprising a signal processing unit which receives at least one of an image signal input externally and the alarm message signal and then processes the received signal to be displayed on the display, and a user input-unit for a user's manipulation,
wherein the microcomputer determines whether displaying the alarm data is selected via the user input unit while the alarm message is being displayed on the display, and if it is determined that displaying the alarm data is selected, the microcomputer controls the signal processing unit so that the alarm data stored in the storage are processed corresponding to the alarm message and then displayed on the display.

15. The display apparatus according to claim 14, wherein the microcomputer determines whether the alarm data is stored in the storage if indicating the alarm data is selected via the user input unit while the alarm message is not displayed on the display, and if it is determined that the alarm data is stored in the storage, the microcomputer controls the UI generating unit and the signal processing unit so that an alarm message list in which the alarm messages corresponding to the stored alarm data are arranged sequentially in a row according to a stored order is displayed on the display.

16. The display apparatus according to claim 15, wherein the microcomputer determines which alarm message in the alarm message list is selected via the user input unit while the alarm message list is being displayed on the display, and if one of the alarm messages is selected, the microcomputer controls the signal processing unit so that the alarm data stored in the storage are processed corresponding to the selected alarm message and then displayed on the display.

17. The display apparatus according to claim 16, wherein the alarm data comprise at least one of name information of the electronic appliance, transfer date information, cause information of the abnormal operations, and simplified solution information recommended for resolving the cause of the abnormal operations.

18. The display apparatus according to claim 17, wherein the alarm messages comprise at least one of alarm information for notifying the reception of the alarm data, electronic appliance indicating information corresponding to the electronic appliance which transfers the received alarm data, and simplified cause information with respect to the cause information included in the alarm data, as one of the forms of text type or symbol type.

19. The display apparatus according to claim 18, wherein the microcomputer previously stores the abnormal operation information related to the pre-set abnormal operations which trigger the generation of the alarm data, checks whether the operation of the display apparatus is normally progressed, compares a result of the check with the abnormal operation information, and if operation state of the display apparatus is determined to be a pre-set abnormal operation state, the microcomputer creates the alarm data, stores the data in the storage, controls the UI generating unit and the signal processing unit so that a predetermined alarm message corresponding to the alarm data is displayed on a portion of the display in order to notify the reception of the alarm data.

20. A control method of a display apparatus comprising:
a display network module connected to a network for conducting data communications; and
a display control unit for determining whether predetermined alarm data are received from an external electronic appliance connected via the display network module, storing the predetermined alarm data if the alarm data are received, and displaying a predetermined alarm message corresponding to the alarm data to notify the reception of the alarm data on a portion of a display.

21. The control method according to claim 20, wherein the display control unit comprises a User Interface (UI) generating unit for generating the alarm message signal to indicate the alarm message.

22. The control method according to claim 21, wherein a microcomputer controls the UI generating unit so that the display of the alarm message is terminated if a predetermined period has elapsed after the alarm message was displayed on a portion of the display.

23. The control method according to claim 22, wherein the microcomputer determines whether displaying the alarm data is selected via a user input unit while the alarm message is being displayed on the display, and if it is determined that displaying the alarm data is selected, the microcomputer controls a signal processing unit so that the stored alarm data stored in a storage are processed corresponding to the alarm message and then displayed on the display.

24. The control method according to claim 23, wherein the microcomputer determines whether the alarm data is stored in the storage if indicating the alarm data is selected via the user input unit while the alarm message is not displayed on the display, and if it is determined that the alarm data is stored in the storage, the microcomputer controls the UI generating unit and the signal processing unit so that an alarm message list in which the alarm messages corresponding to the stored alarm data are arranged sequentially in a row according to a stored order and displayed on the display.

25. The control method according to claim 24, wherein the microcomputer determines whether an alarm message in the alarm message list is selected via the user input unit while the alarm message list is being displayed on the display, and if one of the alarm messages is selected, the microcomputer controls the signal processing unit so that the alarm data stored in the storage are processed corresponding to the selected alarm message and then displayed on the display.

26. The control method according to claim 25, wherein the microcomputer previously stores abnormal operation information related to pre-set abnormal operations which trigger a generation of the alarm data, checks whether an operation state of the display apparatus is normally progressed, compares a result of the check with the abnormal operation information, and if the operation state of the display apparatus is determined to be a pre-set abnormal operation state, the microcomputer creates the alarm data, stores the data in the storage, controls the UI generating unit and the signal processing unit so that the predetermined alarm message corresponding to the alarm data is displayed on a portion of the display in order to notify the reception of the alarm data.
